(19) United States
(12) Patent Application Publication
(10) Pub. No.: US 2008/0221285 A1
(43) Pub. Date: Sep. 11, 2008

(54) Solvent-Stable Metal Complexes Having Slightly Coordinating Counter Anions as Polymerisation Catalysts

(75) Inventors: Hans-Michael Walter, Freinsheim (DE); Mirjam Herrlich-Loos, Mannheim (DE); Fritz Elmar Kuehn, Nandlstadt (DE); Yanmei Zhang, Muenchen (DE); Brigitte Voit, Dresden (DE); Radha Krishnan Narayanan, Dresden (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF SE, Ludwigshafen (DE)

(21) Appl. No.: 11/997,912

(22) PCT Filed: Aug. 11, 2006
(86) PCT No.: PCT/EP2006/065271

§ 371 Date: Feb. 5, 2008

(30) Foreign Application Priority Data
Aug. 12, 2005 (DE) 10 2005 038 283.5

(51) Int. Cl. C08F 4/06; C07F 11/00

(52) U.S. Cl. 526/120; 526/134; 556/57

(57) ABSTRACT

The invention relates to a solvent-stable metal catalyst having slightly coordinating counter anions of formula I [M(L)ₐ(Z)_{b}]^{m+}m(A⁻)(I), wherein M represents a transition metal of groups 3-12 of the periodic system, a lanthanide or a metal of groups 2 or 13 of the periodic system; L represents a solvent molecule; Z represents a mono or polycharged ligand; A⁻ represents a slightly or non coordinated anion; a represents a whole number which is greater than or equal to 1; b represents a whole number which is greater than or equal to 1, whereby the total from a and b is between 4 and 8, and m represents a whole number from 1 6. The invention also relates to a method for polymerising olefinically unsaturated compounds in the presence of said catalyst and copolymers which are made of monomers comprising isobutene and at least one vinylaromatic compound which is obtained according to said inventive method.

The present invention relates to a solvent-stabilized metal catalyst with weakly coordinating counter anions of the formula I

[M(L)ₐ(Z)_{b}]^{m+}m(A⁻) (I)

in which
M is a transition metal of group 3 to 12 of the periodic table, a lanthanide or a metal of group 2 or 13 of the periodic table;
L is a solvent molecule;
Z is a singly or multiply charged ligand;
A⁻ is a weakly coordinating or noncoordinating anion;
a is an integer greater than or equal to 1;
b is an integer greater than or equal to 1;
where the sum of a plus b is from 4 to 8; and
m is an integer from 1 to 6.

The invention further relates to the use of such a catalyst in the polymerization of olefinically unsaturated compounds. The invention also provides a process for polymerizing olefinically unsaturated compounds and especially for preparing highly reactive isobutene homo- or copolymers in the presence of this catalyst. The invention finally relates to copolymers which are formed from monomers comprising isobutene and at least one vinylaromatic compound and which are obtainable by the process according to the invention.

Highly reactive polyisobutene homo- or copolymers are understood to mean, in contrast to so-called low-reactivity polymers, those polyisobutenes which comprise a high content of terminal ethylenic double bonds. In the context of the present invention, highly reactive polyisobutenes shall be understood to mean those polyisobutenes which have a content of vinylidene double bonds (α-double bonds) of at least 60 mol %, preferably of at least 70 mol % and in particular of at least 80 mol %, based on the polyisobutene macromolecules. In the context of the present invention, vinylidene groups are understood to mean those double bonds whose position in the polyisobutene macromolecule is described by the general formula

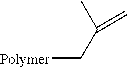

i.e. the double bond is in the α-position in the polymer chain. “Polymer” represents a polyisobutene radical shortened by one isobutene unit. The vinylidene groups exhibit the highest reactivity, whereas a double bond lying further toward the interior of the macromolecules exhibits no or in any case lower reactivity in functionalization reactions. Highly reactive polyisobutenes are used, inter alia, as intermediates for producing additives for lubricants and fuels, as described, for example in DE-A 2702604.

Such highly reactive polyisobutenes are obtainable, for example, by the process of DE-A 2702604 by cationic polymerization of isobutene in the liquid phase in the presence of boron trifluoride as a catalyst. A disadvantage here is that the resulting polyisobutenes have a relatively high polydispersity. The polydispersity is a measure of the molecular weight distribution of the resulting polymer chains and corresponds to the quotient of weight-average molecular weight M_{w} and number-average molecular weight Mₙ (PDI=M_{w}/Mₙ).

Polyisobutenes having a similarly high content of terminal double bonds, but having a narrower molecular weight distribution, are obtainable, for example, by the processes of EP-A 145235, U.S. Pat. No. 5,408,018 and WO 99/64482, the polymerization being effected in the presence of a deactivated catalyst, for example of a complex of boron trifluoride, alcohols and/or ethers. A disadvantage here is that it is necessary to work at temperatures distinctly below 0° C. in order actually to obtain highly reactive polyisobutenes.

Highly reactive polyisobutenes are also obtainable by living cationic polymerization of isobutene and subsequent dehydrohalogenation of the resulting polymerization product, for example by the process from U.S. Pat. No. 5,340,881. Here too, it is necessary to work at low temperatures to prepare highly reactive polyisobutenes.

EP-A 1344785 describes a process for preparing highly reactive polyisobutenes using a solvent-stabilized transition metal complex with weakly coordinating anions as a polymerization catalyst. Suitable metals mentioned are generally those of group 3 to 12 of the periodic table; however, only manganese is used in the examples. Although it is also possible in this process to polymerize at reaction temperatures above 0° C., a disadvantage is that the polymerization times are unacceptably long, so that economic utilization of this process becomes unattractive.

It was therefore an object of the present invention to provide a polymerization catalyst with which ethylenically unsaturated monomers can be polymerized advantageously. In particular, the catalyst should enable the preparation of highly reactive polyisobutene homo- or copolymers at temperatures of at least 0° C. with short polymerization times.

The object was achieved by a catalyst of the formula I

[M(L)ₐ(Z)_{b}]^{m+}m(A⁻) (I)

in which
M is a transition metal of group 3 to 12 of the periodic table, a lanthanide or a metal of group 2 or 13 of the periodic table;
L is a solvent molecule;
Z is a singly or multiply charged ligand;
A⁻ is a weakly coordinating or non coordinating anion;
a is an integer greater than or equal to 1;
b is an integer greater than or equal to 1;
where the sum of a plus b is from 4 to 8; and
m is an integer from 1 to 6.

The details of suitable and preferred embodiments of the subject matter of the invention which follow, especially of the inventive catalyst, of the process according to the invention and the monomers and catalysts used therein and of the polymers obtainable thereby, apply both taken alone and especially in combination with one another.

In the context of the present invention, isobutene homopolymers are understood to mean those polymers which, based on the polymer, are formed from isobutene to an extent of at least 98 mol %, preferably to an extent of at least 99 mol %. Accordingly, isobutene copolymers are understood to mean those polymers which comprise more than 2 mol % of monomers other than isobutene in copolymerized form.

In the context of the present invention, the following definitions apply to generically defined radicals:

C₁-C₄-alkyl is a linear or branched alkyl radical having from 1 to 4 carbon atoms. Examples thereof are methyl, ethyl, n-propyl, isopropyl, n-butyl, 2-butyl, isobutyl or tert-butyl. C₁-C₂-alkyl is methyl or ethyl; C₁-C₃-alkyl is additionally n-propyl or isopropyl.

C₁-C₈-Alkyl is a linear or branched alkyl radical having from 1 to 8 carbon atoms. Examples thereof are the abovementioned C₁-C₄-alkyl radicals and additionally pentyl, 1-methylbutyl, 2-methylbutyl, 3-methylbutyl, 2,2-dimethylpropyl, 1-ethylpropyl, hexyl, 1,1-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, 1-ethyl-2-methylpropyl, heptyl, octyl and their constitutional isomers such as 2-ethylhexyl.

C₁-C₄-Haloalkyl is a linear or branched alkyl radical which has from 1 to 4 carbon atoms and is substituted by at least one halogen radical. Examples thereof are CH₂F, CHF₂, CF₃, CH₂Cl, CHCl₂, CCl₃, CH₂FCH₂, CHF₂CH₂, CF₃CH₂ and the like.

In the context of the present invention, aryl is optionally substituted phenyl, optionally substituted naphthyl, optionally substituted anthracenyl or optionally substituted phenanthrenyl. The aryl radicals may bear from 1 to 5 substituents which are, for example, selected from hydroxyl, C₁-C₈-alkyl, C₁-C₈-haloalkyl, halogen, NO₂ and phenyl. Examples of aryl are phenyl, naphthyl, biphenyl, anthracenyl, phenanthrenyl, tolyl, nitrophenyl, hydroxyphenyl, chlorophenyl, dichlorophenyl, pentafluorophenyl, pentachlorophenyl, (trifluoromethyl)phenyl, bis(trifluoromethyl)phenyl, (trichloro)methylphenyl, bis(trichloromethyl)phenyl and hydroxynaphthyl.

In the context of the present invention, arylalkyl is an aryl group which is bonded via an alkylene group. Examples thereof are benzyl and 2-phenylethyl.

C₁-C₄ carboxylic acids are aliphatic carboxylic acids having from 1 to 4 carbon atoms. Examples thereof are formic acid, acetic acid, propionic acid, butyric acid and isobutyric acid.

C₁-C₄-alcohol represents a C₁-C₄-alkyl radical as defined above in which at least one hydrogen atom has been replaced by a hydroxyl group. It is preferably a monohydric alcohol, i.e. a C₁-C₄-alkyl group in which one hydrogen atom has been replaced by a hydroxyl group. Examples thereof are methanol, ethanol, propanol, isopropanol, n-butanol, sec-butanol, isobutanol and tert-butanol.

In the context of the present invention, halogen is fluorine, chlorine, bromine or iodine.

In the context of the present invention, vinylaromatic compounds are styrene and styrene derivatives such as α-methylstyrene, C₁-C₄-alkylstyrenes, such as 2-, 3- or 4-methylstyrene and 4-tert-butylstyrene, and halostyrenes such as 2-, 3- or 4-chlorostyrene. Preferred vinylaromatic compounds are styrene and 4-methylstyrene and also mixtures thereof, particular preference being given to styrene.

Transition metals of group 3 to 12 are also known as metals of transition group I. to VIII. or are referred to simply as transition metals.

Examples of suitable transition metals are titanium, zirconium, vanadium, chromium, molybdenum, tungsten, manganese, iron, ruthenium, osmium, cobalt, rhodium, nickel, palladium, platinum, copper and zinc. Preferred transition metals are vanadium, chromium, molybdenum, manganese, iron, cobalt, nickel, copper and zinc, particular preference being given to manganese.

Lanthanides are understood to mean metals having the atomic number 58 to 71 in the periodic table, such as cerium, praseodimium, neodimium, samarium and the like. Preferred lanthanides are cerium and samarium.

The metals of group 2 or 13 of the periodic table are also referred to as metals of main group 2 or 3. Examples thereof are beryllium, magnesium, calcium, aluminum and gallium. Preferred main group metals are magnesium and aluminum.

When M is a transition metal of group 3 to 12 of the periodic table, it is preferably selected from vanadium, chromium, molybdenum, manganese, iron, cobalt, nickel, copper and zinc.

When M is a lanthanide, it is preferably selected from cerium and samarium.

When M is a metal of group 2 or 13 of the periodic table, it is preferably selected from magnesium and aluminum.

M is more preferably a transition metal of group 3 to 12 of the periodic table. More preferably, M is a transition metal which is selected from vanadium, chromium, molybdenum, manganese, iron, cobalt, nickel, copper and zinc. In particular, M is molybdenum.

In the catalyst of the formula I, the central metal M may assume an oxidation number of I to VII. M is present preferably in an oxidation number of II, III or IV, more preferably of II or III and in particular of III.

L is a solvent molecule which can bind coordinatively. These are molecules which are typically used as a solvent but simultaneously have at least one dative moiety, for example a free electron pair which can enter into a coordinative bond to the central metal. Examples thereof are nitriles such as acetonitrile, propionitrile and benzonitrile, open-chain and cyclic ethers such as diethyl ether, dipropyl ether, diisopropyl ether, methyl tert-butyl ether, ethyl tert-butyl ether, tetrahydrofuran and dioxane, carboxylic acids, in particular C₁-C₄-carboxylic acids such as formic acid, acetic acid, propionic acid, butyric acid and isobutyric acid, carboxylic esters, in particular the esters of C₁-C₄-carboxylic acids with C₁-C₄-alcohols, such as ethyl acetate and propyl acetate, and carboxamides, in particular of C₁-C₄-carboxylic acids with di(C₁-C₄-alkyl)amines, such as dimethylformamide.

Preferred solvent molecules are those which firstly bind coordinatively to the central metal but secondly are not strong Lewis bases, so that they can be displaced readily from the coordination sphere of the central metal in the course of the polymerization. The solvent ligands L, which may be the same or different, are preferably selected from nitriles of the formula N≡C—R¹ in which R¹ is C₁-C₈-alkyl or aryl, and open-chain and cyclic ethers.

In the nitriles, the R¹ radical is preferably C₁-C₄-alkyl or phenyl. Examples of such nitriles are acetonitrile, propionitrile, butyronitrile, pentylnitrile and benzonitrile. More preferably, R¹ is methyl, ethyl or phenyl, i.e. the nitrile is more preferably selected from acetonitrile, propionitrile and benzonitrile. In particular, R¹ is methyl or phenyl, i.e. the nitrile is in particular acetonitrile or benzonitrile. R¹ is especially methyl, i.e. the nitrile is especially acetonitrile.

Suitable open-chain and cyclic ethers are, for example, diethyl ether, dipropyl ether, diisopropyl ether, methyl tert-butyl ether, ethyl tert-butyl ether, tetrahydrofuran and dioxane, preference being given to diethyl ether and tetrahydrofuran.

More preferably, L is a nitrile of the formula N≡C—R¹ in which R¹ is preferably methyl, ethyl or phenyl, more preferably methyl or phenyl and in particular methyl.

L may be the same or different solvent molecules. However, in compound I, all L are preferably the same solvent ligands.

Z derives from a singly or multiply charged anion and thus differs from the ligand L in particular by the charge and also by the stronger coordination to the central metal M.

Z may either be a charged monodentate ligand or a singly or a multiply charged bi- or multidentate ligand.

Examples of charged monodentate ligands are halides, pseudohalides, hydroxyl, nitrite (NO₂⁻), alkoxides and acid anions.

Examples of singly or multiply charged bi- or multidentate ligands are di- and polycarboxylic acid anions, acetyl acetonate and ethylenediaminetetraacetate (EDTA).

Halides are, for example, fluoride, chloride, bromide and iodide, preference being given to chloride and bromide. Halide is more preferably chloride.

Pseudohalides are, for example, cyanide (CN⁻), thiocyanate (SCN⁻), cyanate (OCN⁻), isocyanate (CNO⁻) and azide (N₃⁻). Preferred pseudohalides are cyanide and thiocyanate.

Suitable alkoxides are compounds of the formula RO⁻ in which R is C₁-C₈-alkyl or arylalkyl. R is preferably C₁-C₄-alkyl or benzyl. Examples of such alkoxides are methoxide, ethoxide, propoxide, isopropoxide, n-butoxide, isobutoxide, tert-butoxide and benzylalkoxide.

Suitable acid anions are the acid anions of aliphatic or aromatic monocarboxylic acids having from 1 to 8 carbon atoms, such as formic acid, acetic acid, propionic acid, butyric acid, isobutyric acid, valeric acid, isovaleric acid, caproic acid, caprylic acid and benzoic acid.

Suitable dicarboxylic acid anions are the mono- and dianions of aliphatic or aromatic dicarboxylic acids having from 2 to 10 carbon atoms, such as oxalic acid, malonic acid, succinic acid, glutaric acid, adipic acid, pimelic acid, azelaic acid, sebacic acid and phthalic acid.

Suitable polycarboxylic acid anions are the mono- and polyanions of polycarboxylic acids such as citric acid or else the oligomers of ethylenically unsaturated carboxylic acids such as acrylic acid or methacrylic acid.

Z derives preferably from a monodentate singly charged anion. Z more preferably derives from a halide or pseudohalide and more preferably from a halide. In particular, Z derives from chloride.

The definition of the index b depends upon whether the ligand Z is a monodentate or else a multidentate ligand. When Z is a bi- or multidentate ligand, the index b is the number of binding sites with which this ligand Z coordinates to the metal multiplied by the number of these bi- or multidentate ligands which are coordinated to M. For monodentate ligands Z, b is of course just the number of coordinatively bound ligands.

The coordination number of the metal, i.e. the sum of a and b, is from 4 to 8. It is required that at least one ligand L and at least one ligand Z are present in the coordination sphere of the metal.

a is preferably an integer from 1 to 5. When Z is a monodentate ligand, a is more preferably 5.

b is preferably an integer from 1 to 4. When Z is a monodentate ligand, b is more preferably 1.

The sum of a and b is preferably from 4 to 6. It is more preferably 6. In this case, the metal complexes are present preferably in octahedral or virtually octahedral form.

m is preferably an integer from 1 to 3. m is especially 2.

A⁻ is a weakly coordinating or noncoordinating anion. Weakly coordinating or noncoordinating anions are those which do not enter into a coordinative bond with the central atom, and which thus do not have a Lewis-basic moiety. Generally, the weakly coordinating or noncoordinating anions are those whose negative charge is delocalized over a large surface of non-nucleophilic and chemically robust groups. For example, weakly coordinating or noncoordinating anions are mono- or binuclear anions with a Lewis-acidic central atom whose electron deficiency is, however, compensated by the binding of a weakly coordinating substituent.

The weakly coordinating or noncoordinating anion A⁻ is preferably selected from BX₄⁻, B(Ar)₄⁻, bridged anions of the formula [(Ar)₃B-(μ-Y)—B(Ar)₃]⁻, SbX₆⁻, Sb₂X₁₁⁻, AsX₆⁻, As₂X₁₁⁻, ReX₆⁻, Re₂X₁₁⁻, AlX₄⁻, Al₂X₇⁻, OTeX₅⁻, B(OTeX₅)₄⁻, Nb(OTeX₅)₄]₂⁻, OSeX₅⁻, trifluoromethanesulfonate, perchlorate, carborates and carbon cluster anions, where
Ar is phenyl which may bear from 1 to 5 substituents which are selected from halogen, C₁-C₄-alkyl and C₁-C₄-haloalkyl;
Y is a bridging group; and
X is fluorine or chlorine.

Ar is, for example, phenyl, pentafluorophenyl or bis(trifluoromethyl)phenyl, e.g. 3,5-bis(trifluoromethyl)phenyl. Ar in the anion B(Ar)₄⁻ is preferably a substituted phenyl, more preferably bis(trifluoromethyl)phenyl, e.g. 3,5-bis(trifluoromethyl)phenyl, or in particular pentafluorophenyl. In the bridged anions too, Ar is preferably a substituted phenyl group, more preferably bis(trifluoromethyl)phenyl, e.g. 3,5-bis(trifluoromethyl)phenyl, or in particular pentafluorophenyl.

The bridging group Y may, for example, be CN, NH₂ or a cyclic bridging unit. Cyclic bridging units are those cycles which are bonded via two Lewis-basic moieties. Examples thereof are saturated or unsaturated heterocycles having at least 2 heteroatoms, preferably having at least 2 nitrogen atoms, such as pyrazolediyl, pyrazolinediyl, pyrazolidinediyl, imidazolediyl, imidazolinediyl, imidazolidinediyl, triazolediyl, triazolinediyl, triazolidinediyl, pyrimidinediyl, pyrazinediyl and pyridazinediyl. Preference is given to aromatic heterocycles. Particularly preferred cyclic bridging units are imidazol-1,3-yl and triazolediyl, e.g. [1,2,4]triazole-2,4-diyl.

Y is preferably selected from cyclic bridging groups, particular preference being given to triazolediyl and in particular imidazol-1,3-yl.

X is preferably fluorine.

In the context of the present invention, carborates are understood to mean the anions of carboranes, i.e. of cage-like boron-carbon compounds, for example the anions of closo-, nido- or arachno-carboranes. Examples thereof are the following closo-carborates: [CB₁₁H₁₂]⁻, [CB₉H₁₀]⁻ and [CB₁₁(CH₃)₁₂]⁻. However, preference is given to those carborates in which some of the hydrogen atoms have been substituted by halogen atoms. Examples thereof are [CB₁₁H₆Cl₆]⁻, [1-H—CB₁₁(CH₃)₅Cl₆]⁻, [CB₁₁H₆F₆]⁻ and [1-H—CB₁₁(CH₃)₅F₆]⁻.

In the context of the present invention, carbon cluster anions are understood to mean the anions of carbon clusters, for example of fullerenes. An example thereof is C₆₀⁻.

The weakly coordinating or noncoordinating anion A⁻ is more preferably selected from BX₄⁻, B(Ar)₄⁻, bridged anions of the formula [(Ar)₃B-(μ-Y)—B(Ar)₃]⁻, SbX₆⁻, Sb₂X₁₁⁻, AsX₆⁻, As₂X₁₁⁻, ReX₆⁻, Re₂X₁₁⁻, AlX₄⁻, Al₂X₇⁻, OTeX₅⁻, B(OTeX₅)₄⁻, Nb(OTeX₅)₆⁻, [Zn(OTeX₅)₄]₂⁻, OSeX₅⁻, trifluoromethanesulfonate and perchlorate.

More preferred weakly coordinating or noncoordinating anions A⁻ are selected from B(Ar)₄⁻ and bridged anions of the formula [(Ar)₃B-(μ-Y)—B(Ar)₃]⁻. Preference is given to those borates B(Ar)₄⁻ in which Ar is 3,5-bis(trifluoromethyl)phenyl or in particular pentafluorophenyl. Preferred bridged anions are those in which Ar is pentafluorophenyl and Y is an imidazole-1,3 bridge.

The catalysts of the formula I can be prepared by commonly known processes for preparing transition metal complexes with solvent molecules in the coordination sphere. The weakly coordinating or noncoordinating anion A⁻ can be introduced in analogy to the known processes, as described, for example, in W. E. Buschmann, J. S. Miller, Chem. Eur. J. 1998, 4(9), 1731, R. E. LaPointe, G. R. Ruff, K. A. Abboud, J. Klosin, New Family of Weakly Coordinating Anions, J. Am. Chem. Soc. 2000, 122(39), 9560, W. E. Buschmann, J. S. Miller, Inorganic Chemistry 33, 2002, 83, O. Nuyken, F. E. Kühn, Angew. Chem. Int. Ed. Engl. 2003, 42, 1307, O. Nuyken, F. E. Kühn, Chem. Eur. J. 2004, 10, 6323 and EP-A-1344785, and also in the literature cited therein, which are hereby fully incorporated by reference.

For example, the catalyst of the formula I can be prepared by dissolving a salt of the formula M^{x+}Z^{y-}_{x/y} in a solvent which corresponds to the solvent molecule L. In the case that Z is not Cl, a salt of the formula M^{x+}(Cl⁻)ₓ is added as well. To introduce the anion A⁻, this solution is then admixed with a silver salt of the appropriate anion, especially with [Ag(L)₄]⁺(A⁻), preferably at a temperature of from −10° C. to room temperature. The silver chloride which precipitates is removed from the reaction solution, for example by filtration, decanting or centrifugation. Subsequently, the solvent is generally at least partly removed, which can be done, for example, by distillation, especially under reduced pressure. The catalyst I can be isolated by customary processes, for example by removing the solvent to dryness or preferably by crystallization in suitable solvents.

Alternatively, isolated mono- or polynuclear complexes of the metal M with Z and L as ligands of the above-described ion exchange method can be subjected to the introduction of the anion A⁻. Such isolable solvent complexes can be prepared in analogy to processes as described, for example, in F. A. Cotton, R. H. Niswander, J. C. Sekutowski, Inorg. Chem. 1979, 18, 1149, I. R. Anderson, J. C. Sheldon, Aust. J. Chem. 1965, 18, 271, J. V. Brencic, F. A. Cotton, Inorg. Chem. 1969, 8, 7 and R. W. McGaff, N. C. Dopke, R. K. Hayashi, D. R. Powell, P. M. Treichel, Polyhedron 2000, 19, 1245 and in the literature cited therein, which is hereby fully incorporated by reference.

The present invention further provides for the use of the inventive catalyst as a polymerization catalyst in the polymerization of olefinically unsaturated compounds.

Preferred olefinically unsaturated compounds are specified below.

Particular preference is given to the use of the inventive catalyst I for preparing highly reactive isobutene homo- or copolymers and especially of isobutene homo- or copolymers having a content of terminal vinylidene double bonds of at least 80 mol %, particularly preferably at least 85 mol %, more preferably at least 90 mol % and in particular at least 95 mol %, for example about 100 mol %.

Preferred isobutene copolymers are specified below.

The present invention further provides a process for polymerizing olefinically unsaturated monomers, which comprises polymerizing the olefinically unsaturated monomers in the presence of an inventive catalyst of the formula I.

Reference is hereby made to the remarks made above on preferred components of the catalyst (M, L, Z, A⁻, a, b and m).

In the process according to the invention, the catalysts of the formula I are used in relation to the monomers used in a molar ratio of from 1:10 to 1:1 000 000, more preferably from 1:5 000 to 1:500 000 and in particular from 1:5000 to 1:100 000, for example from 1:10 000 to 1:100 000.

The concentration of the catalysts I used in the reaction mixture is in the range of preferably from 0.01 mmol/l to 5 mmol/l, particularly preferably from 0.01 to 1 mmol/l, more preferably from 0.01 to 0.5 mmol/l and in particular from 0.01 to 0.1 mmol/l.

Useful ethylenically unsaturated monomers are all monomers which are polymerizable under cationic polymerization conditions. Examples thereof are linear alkenes such as ethene, propene, n-butene, n-pentene and n-hexene, alkadienes, such as butadiene and isoprene, isoalkenes such as isobutene, 2-methylbutene-1, 2-methylpentene-1, 2-methylhexene-1, 2-ethylpentene-1, 2-ethylhexene-1 and 2-propylheptene-1, cycloalkenes such as cyclopentene and cyclohexene, vinylaromatic compounds such as styrene, α-methylstyrene, 2-, 3- and 4-methylstyrene, 4-tert-butylstyrene and 2-, 3- and 4-chlorostyrene, and olefins which have a silyl group such as 1-trimethoxysilyl-ethene, 1-(trimethoxysilyl)propene, 1-(trimethoxysilyl)-2-methylpropene-2, 1-[tri(methoxyethoxy)silyl]ethene, 1-[tri(methoxyethoxy)silyl]propene, and 1-[tri(methoxyethoxy)silyl]-2-methylpropene-2, and also mixtures of these monomers.

Preferred monomers are isobutene, isobutenic monomer mixtures, styrene, styrenic monomer mixtures, styrene derivatives, especially α-methylstyrene and 4-methylstyrene, the abovementioned cycloalkenes, the abovementioned alkadienes and mixtures thereof.

Particularly preferred monomers are isobutene, isobutenic monomer mixtures, styrene, styrenic monomer mixtures and mixtures thereof. In particular, the monomers used in the polymerization process according to the invention are isobutene, styrene or mixtures thereof.

When isobutene or an isobutenic monomer mixture is used as the monomer to be polymerized, suitable isobutene sources are both isobutene itself and isobutenic C₄ hydrocarbon streams, for example C₄ raffinates, C₄ cuts from isobutane dehydrogenation, C₄ cuts from streamcrackers and from FCC crackers (fluid catalyzed cracking), provided that they have been freed substantially from 1,3-butadiene present therein. Suitable C₄ hydrocarbon streams comprise generally less than 500 ppm, preferably less than 200 ppm, of butadiene. The presence of 1-butene and also of cis- and trans-2-butene is substantially uncritical. Typically, the isobutene concentration in the C₄ hydrocarbon streams is in the range from 40 to 60% by weight. The isobutenic monomer mixture may comprise small amounts of contaminants such as water, carboxylic acids or mineral acids, without there being critical losses of yield or selectivity. It is appropriate to prevent enrichment of these impurities by removing such harmful substances from the isobutenic monomer mixture, for example, by adsorption on solid adsorbents such as activated carbon, molecular sieves or ion exchangers.

It is also possible to react monomer mixtures of isobutene or the isobutenic hydrocarbon mixture with olefinically unsaturated monomers which are copolymerizable with isobutene. When monomer mixtures of isobutene with suitable comonomers are to be copolymerized, the monomer mixture comprises preferably at least 5% by weight, more preferably at least 10% by weight and in particular at least 20% by weight of isobutene, and preferably at most 95% by weight, more preferably at most 90% by weight and in particular at most 80% by weight of comonomers.

Useful copolymerizable monomers include vinylaromatics such as styrene and α-methylstyrene, C₁-C₄-alkylstyrenes such as 2-, 3- and 4-methylstyrene and also 4-tert-butylstyrene, isoolefins having from 5 to 10 carbon atoms such as 2-methyl-butene-1, 2-methylpentene-1, 2-methylhexene-1, 2-ethylpentene-1, 2-ethylhexene-1 and 2-propylheptene-1. Useful comonomers are also olefins which have a silyl group such as 1-trimethoxysilylethene, 1-(trimethoxysilyl)propene, 1-(trimethoxysilyl)-2-methylpropene-2, 1-[tri(methoxyethoxy)silyl]ethene, 1-[tri(methoxyethoxy)silyl]propene and 1-[tri(methoxyethoxy)silyl]-2-methylpropene-2.

When copolymers are to be prepared by the process according to the invention, the process can be configured such that preferentially random polymers or preferentially block copolymers are formed. To prepare block copolymers, it is possible, for example, to feed the different monomers successively to the polymerization reaction, in which case the second comonomer is added especially only after the first comonomer has at least partly already polymerized. In this way, it is possible to obtain diblock, triblock and higher block copolymers which, depending on the sequence of monomer addition, have one block of one or another comonomer as the terminal block. In some cases, block copolymers are also formed when all comonomers are fed simultaneously to the polymerization reaction but one polymerizes significantly more rapidly than the other(s). This is the case especially when isobutene and a vinylaromatic compound, especially styrene, are copolymerized in the process according to the invention. This preferably forms block copolymers with a terminal polyisobutene block. This is attributable to the vinylaromatic compound, especially styrene, being polymerized significantly more rapidly than isobutene.

Polymerization can be effected either continuously or batchwise. Continuous processes can be carried out in analogy to known prior art processes for continuously polymerizing isobutene in the presence of Lewis acid catalysts in the liquid phase.

The process according to the invention is suitable both for performance at low temperatures, for example from −78 to 0° C., and at higher temperatures, i.e. at at least 0° C., for example from 0 to 100° C. For economic reasons in particular, the polymerization is carried out preferably at at least 0° C., for example at from 0 to 100° C., more preferably at from 20 to 60° C., in order to minimize the energy and material consumption which is required for cooling. However, it can be carried out just as efficiently at lower temperatures, for example at from −78 to <0° C., preferably at from −40 to −10° C.

When the polymerization is effected at or above the boiling point of the monomer or monomer mixture to be polymerized, it is preferably carried out in pressure vessels, for example in autoclaves or in pressure reactors.

Preference is given to carrying out the polymerization in the presence of an inert diluent. The inert diluent used should be suitable for reducing the increase, generally occurring during the polymerization reaction, in the viscosity of the reaction solution to such an extent that the removal of the heat of reaction formed can be ensured. Suitable diluents are those solvents or solvent mixtures which are inert toward the reagents used. Suitable diluents are, for example, aliphatic hydrocarbons such as butane, pentane, hexane, heptane, octane and isooctane, cycloaliphatic hydrocarbons such as cyclopentane and cyclohexane, aromatic hydrocarbons such as benzene, toluene and the xylenes, and halogenated hydrocarbons such as methyl chloride, dichloromethane and trichloromethane, and also mixtures of the aforementioned diluents. Preference is given to using at least one halogenated hydrocarbon, if appropriate in a mixture with at least one of the aforementioned aliphatic or aromatic hydrocarbons. In particular, dichloromethane is used. Before they are used, the diluents are preferably freed of impurities such as water, carboxylic acids or mineral acids, for example by adsorption on solid adsorbents such as activated carbon, molecular sieves or ion exchangers.

Preference is given to carrying out the polymerization under substantially aprotic, especially under anhydrous, reaction conditions. Aprotic and anhydrous reaction conditions are understood to mean that the water content (or the content of protic impurities) in the reaction mixture is less than 50 ppm and in particular less than 5 ppm. In general, the feedstocks will be dried physically and/or by chemical measures before they are used. In particular, it has been found to be useful to admix the aliphatic or alicyclic hydrocarbons used as solvents, after customary prepurification and predrying, with an organometallic compound, for example an organolithium, organomagnesium or organoaluminum compound, in an amount which is sufficient to remove the water traces from the solvent. The solvent thus treated is then preferably condensed directly into the reaction vessel. It is also possible to proceed in a similar manner with the monomers to be polymerized, especially with isobutene or with the isobutenic mixtures. Drying with other suitable desiccants such as molecular sieves or predried oxides such as aluminum oxide, silicon dioxide, calcium oxide or barium oxide is also suitable. The halogenated solvents for which drying with metals, such as sodium or potassium, or with metal alkyls is not an option are freed of water (traces) with desiccants suitable for this purpose, for example with calcium chloride, phosphorus pentoxide or molecular sieves. It is also possible in a similar manner to dry those feedstocks for which treatment with metal alkyls is likewise not an option, for example vinylaromatic compounds.

The monomer and especially the isobutene or the isobutenic starting material is polymerized spontaneously when the initiator system (i.e. the catalyst I) is mixed with the monomer at the desired reaction temperature. It is possible here to initially charge the monomer, if appropriate in a solvent, bring it to reaction temperature and then add the catalyst I. It is also possible to initially charge the catalyst I, if appropriate in a solvent, and then add the monomer. The start of polymerization is regarded as being that time at which all reactants are present in the reaction vessel. To prepare copolymers, it is possible to initially charge the monomers, if appropriate in a solvent, and then add the catalyst I. The reaction temperature can be established before or after the catalyst addition. It is also possible to first initially charge only one of the monomers, if appropriate in a solvent, then add the catalyst I and, only after a certain time, for example when at least 60%, at least 80% or at least 90% of the monomer has reacted, add the further monomer(s). Alternatively, it is possible to initially charge the catalyst I, if appropriate in a solvent, then add the monomers simultaneously or successively and then establish the desired reaction temperature. The start of polymerization here is regarded as being that time at which the catalyst and at least one of the monomers are present in the reaction vessel.

In addition to the batchwise procedure described here, the polymerization can also be configured as a continuous process. In this case, the feedstocks, i.e. the monomer(s) to be polymerized, if appropriate the solvent and also the catalyst are fed continuously to the polymerization reaction and reaction product is withdrawn continuously, so that more or less steady-state polymerization conditions are established in the reactor. The monomer(s) to be polymerized may be fed as such, diluted with a solvent or as a monomer-containing hydrocarbon stream.

To terminate the reaction, the reaction mixture is preferably deactivated, for example by adding a protic compound, especially by adding water, alcohols such as methanol, ethanol, n-propanol and isopropanol, or mixtures thereof with water, or by adding an aqueous base, for example an aqueous solution of an alkali metal or alkaline earth metal hydroxide such as sodium hydroxide, potassium hydroxide, magnesium hydroxide or calcium hydroxide, of an alkali metal or alkaline earth metal carbonate such as sodium carbonate, potassium carbonate, magnesium carbonate or calcium carbonate, or of an alkali metal or alkaline earth metal hydrogencarbonate such as sodium hydrogencarbonate, potassium hydrogencarbonate, magnesium hydrogencarbonate or calcium hydrogencarbonate.

In a preferred embodiment of the invention, the process according to the invention serves to prepare highly reactive isobutene homo- or copolymers. More preferably, it serves to prepare highly reactive isobutene homo- or copolymers having a content of terminal vinylidene double bonds (α-double bonds) of at least 80 mol %, preferably of at least 85 mol %, more preferably of at least 90 mol % and in particular of at least 95 mol %, for example of about 100 mol %.

Preferred isobutene copolymers are copolymers which are formed from monomers comprising isobutene and at least one vinylaromatic compound. Particularly preferred copolymers are isobutene-styrene copolymers.

Accordingly, the process according to the invention serves, in a preferred embodiment, to prepare copolymers which are formed from monomers comprising isobutene and at least one vinylaromatic compound, and especially isobutene-styrene copolymers, having a content of terminal vinylidene double bonds (α-double bonds) of at least 50 mol %. It more preferably serves to prepare highly reactive copolymers which are formed from monomers comprising isobutene and at least one vinylaromatic compound, and especially highly reactive isobutene-styrene copolymers, having a content of terminal vinylidene double bonds (α-double bonds) of at least 60 mol %, preferably of at least 70 mol %, particularly preferably of at least 80 mol %, more preferably of at least 85 mol %, even more preferably of at least 90 mol % and in particular of at least 95 mol %, for example of about 100 mol %.

To prepare such copolymers, isobutene or an isobutenic hydrocarbon cut is copolymerized with styrene. More preferably, such a monomer mixture comprises from 5 to 95% by weight, more preferably from 30 to 70% by weight of styrene.

In the copolymerization of isobutene or isobutenic hydrocarbon cuts with at least one vinylaromatic compound, especially with styrene, block copolymers are preferably formed even when the comonomers are added simultaneously, in which case the isobutene block generally constitutes the terminal, i.e. the last-formed block.

The polymers prepared by the process according to the invention, especially the isobutene homo- or copolymers and especially the isobutene homopolymers, preferably have a polydispersity (PDI=M_{w}/Mₙ) of preferably from 1.0 to 3.0, particularly preferably from 1.0 to 2.5, more preferably from 1.0 to 2.0, even more preferably from 1.0 to 1.8 and in particular of from 1 to 1.5.

The polymers prepared by the process according to the invention, especially the isobutene homo- or copolymers, preferably have a number-average molecular weight Mₙ of from 500 to 1 000 000, particularly preferably from 500 to 250 000, more preferably from 500 to 100 000, even more preferably from 500 to 80 000 and in particular from 500 to 60 000.

Even more preferably, isobutene homopolymers have a number-average molecular weight Mₙ of from 500 to 10 000 and in particular of from 500 to 5000, for example of about 1000 or about 2300.

Copolymers which are formed from monomers comprising isobutene and at least one vinylaromatic compound, and especially isobutene-styrene copolymers, have, especially when they are to be used as thermoplastics, a number-average molecular weight Mₙ of preferably from 500 to 1 000 000, particularly preferably from 10 000 to 1 000 000, more preferably from 50 000 to 1 000 000 and in particular from 50 000 to 500 000.

The data given in the context of the invention for weight-average and number-average molecular weights M_{w} and Mₙ and their quotient PDI (PDI=M_{w}/Mₙ) are based on values which have been determined by means of gel permeation chromatography. The proportion of terminal ethylenic double bonds has been determined by means of ¹H NMR.

By virtue of the process according to the invention, ethylenically unsaturated monomers which are polymerized under cationic conditions are successfully polymerized with high conversions within short reaction times even at relatively high polymerization temperatures. When isobutene or isobutenic monomer mixtures are used, highly reactive isobutene homo- or copolymers having a high content of terminal vinylidene double bonds and having a quite narrow molecular weight distribution are obtained.

The process according to the invention can not only be carried out at temperatures of at least 0° C. but additionally allows distinctly shorter reaction times for a comparable conversion and comparable products than the process of EP 1344785.

For an isobutene conversion of at least 80%, for example of at least 90%, a polymerization time of at most 2 hours, more preferably of at most one hour, is preferably required.

The present invention further provides a copolymer formed from monomers comprising isobutene and at least one vinylaromatic compound, which is obtainable by the polymerization process according to the invention. The inventive copolymers preferably have a content of terminal vinylidene double bonds (α-double bonds) of at least 50 mol %. More preferably, the inventive copolymers are highly reactive, i.e. they have a high content of terminal vinylidene double bonds (α-double bonds), for example of at least 60 mol %, preferably of at least 70 mol %, particularly preferably of at least 80 mol %, more preferably at least 85 mol % and in particular of at least 90 mol %, for example of at least 95 mol %, or of about 100 mol %.

The vinylaromatic compound is preferably styrene or 4-methylstyrene and more preferably styrene. Accordingly, particularly preferred copolymers are isobutene-styrene copolymers.

In the inventive copolymer, the total content of copolymerized vinylaromatic compound, based on the total weight of the polymer, is preferably from 5 to 95% by weight and more preferably from 30 to 70% by weight.

The inventive copolymer is preferably a block copolymer, for example a diblock copolymer, triblock copolymer or a higher block copolymer, which comprises at least one polyisobutene block and at least one block of vinylaromatic compounds, the block of vinylaromatic compounds preferably being a styrene block. The polyisobutene block is preferably the terminal, i.e. the last-formed block. The block copolymer is more preferably a diblock copolymer which is formed from a polyisobutene block and a vinylaromatic block, the terminal block preferably being a polyisobutene block. More preferably, the block of vinylaromatic compounds is a styrene block.

The inventive copolymers preferably have a number-average molecular weight Mₙ of from 500 to 1 000 000. Depending on the end use, the inventive copolymers preferably have a higher molecular weight or preferably have a lower molecular weight. When the inventive copolymers are to be used, for example, as thermoplastics, they have a number-average molecular weight Mₙ of preferably from 10 000 to 1 000 000, more preferably from 50 000 to 1 000 000 and in particular from 50 000 to 500 000. When the inventive copolymers are subjected, for example, to functionalization reactions to introduce polar head groups, as described, for example in WO 03/074577 or in the German patent application DE 102005002772.5, they have a number-average molecular weight Mₙ of preferably from 500 to 250 000, particularly preferably from 500 to 100 000, more preferably from 500 to 80 000 and in particular from 1000 to 60 000.

Inventive copolymers which are formed from monomers comprising isobutene and at least one vinylaromatic compound, and especially isobutene-styrene copolymers, can not only be functionalized on the vinylidene-terminated chain ends analogously to highly reactive polyisobutenes in order to optimize them for a certain application, but they additionally have thermoplastic and/or elastic properties. In particular, they or their functionalization products are suitable for use in films, sealant materials, adhesives, adhesion promoters, medical products, for example in the form of certain implants, in particular arterial implants (stents), and compounds.

The functionalization can be effected analogously to derivatization reactions as described, for example, in WO 03/074577 or in the German patent application DE 102005002772.5, which are hereby fully incorporated by reference.

The invention will now be illustrated by the nonlimiting examples which follow.

### EXAMPLES

General

All syntheses and reactions were effected under argon atmosphere using Schlenk technology. Methylene chloride was dried over calcium hydride; n-hexane was dried over sodium/benzophenone and stored over 4 Å molecular sieve; acetonitrile was dried over calcium hydride and stored over 3 Å molecular sieve.

The catalysts used were compounds of the formula I.1

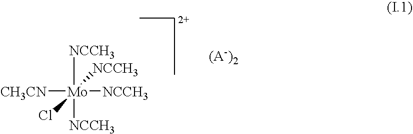

in which A⁻ is one of the anions, A, B or C

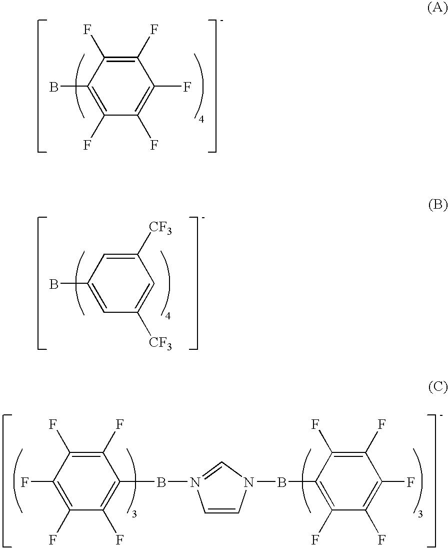

The catalyst composed of the complex I.1 with the counter anion A is referred to as catalyst I.1.A, the corresponding catalyst with the anion B as I.1.B and that with the anion C as I.1.C.

The Mo₂Cl₄(NCCH₃)₄ used in the preparation processes of the catalysts I.1.A, I.1.B and I.1.C was prepared according to the method of F. A. Cotton, R. H. Niswander, J. C. Sekutowski, Inorg. Chem. 1979, 18, 1149.

A catalyst II of the formula [CeCl(CH₃CN)₅]²⁺(A⁻)₂ in which A⁻ is a borate anion of the formula (B) was also used.

### 1.1 Preparation of the Catalyst I.1.A

10 ml of a solution of [Ag(NCCH₃)₄][B(C₆F₅)₄] (344.0 mg, 0.36 mmol) in dry acetonitrile was admixed at room temperature under argon with Mo₂(NCCH₃)₄Cl₄ (45.0 mg, 0.009 mmol). The reaction solution was stirred overnight in the dark. The precipitate formed (AgCl) was removed and the filtrate was concentrated under reduced pressure to a volume of 1.0 ml and stored at −35° C. The catalyst I.1.A was obtained in the form of dark green crystals in a yield of 0.35 g (75% of theory).

Elemental analysis of C₅₈H₁₅MoB₂ClF₄₀N₅ (1694.751):

Calculated: C: 41.10%, H: 0.89%, N: 4.13%.

Found: C: 37.14%, H: 1.21%, N: 3.98%.

IR (KBr, cm⁻¹) (selected bands: ν_{CN}): 2288, 2321.

### 1.2 Preparation of the Catalyst I.1.B

A solution of Ag[B{C₆H₃(CF₃)₂}₄] (0.65 g, 0.67 mmol) in 25 ml of dry acetonitrile was admixed at room temperature under argon with Mo₂(NCCH₃)₄Cl₄ (90 mg, 0.17 mmol). The reaction solution was stirred overnight in the dark. The precipitate formed (AgCl) was removed and the filtrate was concentrated under reduced pressure to a volume of 3 ml and stored at −35° C. The catalyst I.1.B was obtained in the form of a green powder in a yield of 0.27 g (77% of theory).

Elemental analysis of C₇₄H₃₉MoB₂ClF₄₈N₅ (2063.108):

Calculated: C: 43.08%, H: 1.91%, N: 3.39%.

Found: C: 42.60%, H: 2.42%, N: 2.95%.

IR (KBr, cm⁻¹) (selected bands: ν_{CN}): 2322, 2290.

### 1.3 Preparation of the Catalyst I.1.C

A solution of Ag[(C₆F₅)₃B—C₃H₃N₂—B(C₆F₅)₃] (1.00 g, 0.83 mmol) in 25 ml of dry acetonitrile was admixed at room temperature under argon with Mo₂(NCCH₃)₄Cl₄ (100 mg, 0.21 mmol). The reaction solution was stirred overnight in the dark. The precipitate formed (AgCl) was removed and the filtrate was concentrated under reduced pressure to a volume of 3 ml and stored at −35° C. The catalysts I.1.C was obtained in the form of a dark green crystalline solid in a yield of 0.45 g (85% of theory).

Elemental analysis of C₈₈H₂₁MoB₄ClF₆₀N₉ (2518.768):

Calculated: C: 41.96%, H: 0.84%, N: 5.00%.

Found: C: 41.67%, H: 1.21%, N: 5.47%.

IR (KBr, cm⁻) (selected bands: ν_{CN}): 2313, 2286.

### 2. Polymerization Reactions

### 2.1 Homopolymerization of Isobutene

General Procedure:

Pressure tubes are filled at −40° C. with 20 ml of dry dichloromethane and admixed with the catalyst and a magnetic rod. Condensed isobutene is then added. The pressure tubes are sealed and removed from the cooling bath. The polymerization is carried out in a water bath heated to the desired temperature. The polymerization is ended by adding 5 ml of methanol. The reaction mixture is admixed with 0.2 g of 2,2′-methylene-bis(4-methyl-6-di-tert-butyl)phenol in order to prevent oxidation. The solvents are removed in an oil-pump vacuum and the resulting polymer is dried to constant weight at 30° C. in a fine vacuum. The polymers are stored under inert gas atmosphere.

The content of terminal vinylidene double bonds was determined by NMR spectroscopy by evaluating the integrals of the protons on the chain terminus.

### Example 2.1.1

### Polymerization of Isobutene in the Presence of the Catalyst I.1.A

Reaction Conditions:

Isobutene concentration: 1.78 mol/l

Catalyst concentration: 0.5×10⁻⁴ mol/l

Solvent: dichloromethane

Reaction temperature: 30° C.

Polymerization time: 5 hours

Results:

Conversion: 72%

Mₙ of the polymer: 600

PDI of the polymer: 1.67

Content of vinylidene double bonds: 75%

### Comparative Example 2.1.1

### Use of a Catalyst of the Formula [Mn(CH₃CN)₆]²⁺2(A⁻) (Preparation According to EP-A-1344785) in which A⁻ is the Anion A

Reaction Conditions:

Isobutene concentration: 1.78 mol/l

Catalyst concentration: 0.5×10⁻⁴ mol/l

Solvent: dichloromethane

Reaction temperature: 30° C.

Polymerization time: 20 hours

Results:

Conversion: 71%

Mₙ of the polymer: 600

PDI of the polymer: 1.7

Content of vinylidene double bonds: 81%

### Example 2.1.2

### Polymerization of Isobutene in the Presence of the Catalyst I.1.B

Reaction Conditions:

Isobutene concentration: 1.78 mol/l

Catalyst concentration: 0.5×10⁻⁴ mol/l

Solvent: dichloromethane

Reaction temperature: 30° C.

Polymerization time: 0.5 hour

Results:

Conversion: 53%

Mₙ of the polymer: 1100

Content of vinylidene double bonds: 82%

### Example 2.1.3

### Polymerization of Isobutene in the Presence of a Catalyst I.1.C

Reaction Conditions:

Isobutene concentration: 1.78 mol/l

Catalyst concentration: 0.5×10⁻⁴ mol/l

Solvent: dichloromethane

Reaction temperature: 30° C.

Polymerization time: 0.5 hour

Results:

Conversion: 90%

Mₙ of the polymer: 1700

Content of vinylidene double bonds: 74%

### Example 2.1.4

### Polymerization of Isobutene in the Presence of the Catalyst II

Reaction Conditions:

Isobutene concentration: 1.78 mol/l

Catalyst concentration: 0.5×10⁻⁴ mol/l

Solvent: dichloromethane

Reaction temperature: 30° C.

Polymerization time: 0.5 hour

Results:

Conversion: 89%

Mₙ of the polymer: 1700

Content of vinylidene double bonds: 76%

What is claimed is:

1. A catalyst of the formula I
[M(L)ₐ(Z)_{b}]^{m+}m(A⁻) (I)
in which
M is a transition metal of group 3 to 12 of the periodic table, a lanthanide or a metal of group 2 or 13 of the periodic table;
L is a solvent molecule;
Z is a singly or multiply charged ligand;
A⁻ is a weakly coordinating or non coordinating anion;
a is an integer greater than or equal to 1;
b is an integer greater than or equal to 1;
where the sum of a plus b is from 4 to 8; and
m is an integer from 1 to 6.

2. The catalyst according to claim 1, in which the lanthanides are selected from cerium and samarium.

3. The catalyst according to claim 1, in which the metals of group 2 and 13 of the periodic table are selected from magnesium and aluminum.

4. The catalyst according to claim 1, in which M is selected from V, Cr, Mo, Mn, Fe, Co, Ni, Cu and Zn.

5. The catalyst according to claim 4, in which M is Mo.

6. The catalyst according to any of the preceding claims, in which the solvent molecules L are the same or different and are selected from nitrites of the formula N≡C—R¹ in which R¹ is C₁-C₈-alkyl or aryl, and open-chain and cyclic ethers.

7. The catalyst according to claim 6, in which L is a nitrile of the formula N≡C—R¹ in which R¹ is methyl, ethyl or phenyl.

8. The catalyst according to any of the preceding claims, in which Z is a charged monodentate ligand which is selected from halides, pseudohalides, hydroxyl, nitrite, alkoxides and the anions of aliphatic or aromatic monocarboxylic acids, or is a charged multidentate ligand which is selected from acetylacetonate, EDTA and the anions of aliphatic or aromatic dicarboxylic acids or polycarboxylic acids.

9. The catalyst according to claim 8, in which Z is a halide or a pseudohalide.

10. The catalyst according to any of the preceding claims, in which A⁻ is selected from BX₄⁻, B(Ar)₄⁻, bridged anions of the formula [(Ar)₃B-(μ-Y)—B(Ar)₃]⁻, SbX₆⁻, Sb₂X₁₁⁻, AsX₆⁻, As₂X₁₁⁻, ReX₆⁻, Re₂X₁₁⁻, AlX₄⁻, Al₂X₇⁻, OTeX₅⁻, B(OTeX₅)₄⁻, Nb(OTeX₅)₆⁻, [Zn(OTeX₅)₄]⁻, OSeX₅⁻, trifluoromethanesulfonate, perchlorate, carborates and carbon cluster anions, where
Ar is phenyl which may bear from 1 to 5 substituents which are selected from halogen, C₁-C₄-alkyl and C₁-C₄-haloalkyl;
Y is a bridging group; and
X is fluorine or chlorine.

11. The catalyst according to claim 10, in which Y is selected from cyclic bridging groups.

12. The catalyst according to claim 10, in which X is fluorine.

13. The catalyst according to claim 10, in which A⁻ is B(Ar)₄⁻ or [(Ar)₃B-(μ-Y)—B(Ar)₃]⁻.

14. The catalyst according to any of the preceding claims, in which a is an integer from 1 to 5.

15. The catalyst according to any of the preceding claims, in which b is an integer from 1 to 4.

16. The catalyst according to any of the preceding claims, in which m is an integer from 1 to 3.

17. The use of a catalyst as defined in any of claims 1 to 16 as a polymerization catalyst in the polymerization of olefinically unsaturated compounds.

18. The use according to claim 17, wherein the olefinically unsaturated compounds are isobutene, isobutenic monomer mixtures or vinylaromatic compounds.

19. A process for polymerizing olefinically unsaturated compounds, which comprises polymerizing the olefinically unsaturated compounds in the presence of a catalyst as defined in any of claims 1 to 16.

20. The process according to claim 19 for preparing highly reactive isobutene homo- or copolymers.

21. The process according to either of claims 19 and 20 for preparing highly reactive isobutene homo- or copolymers having a content of terminal vinylidene double bonds of at least 80 mol %.

22. The process according to any of claims 19 to 21 for preparing highly reactive isobutene homo- or copolymers having a number-average molecular weight Mₙ of from 500 to 1 000 000.

23. The process according to any of claims 19 to 22 for preparing highly reactive isobutene homo- or copolymers having a polydispersity of at most 2.

24. The process according to any of claims 19 to 23 for preparing copolymers which are formed from monomers comprising isobutene and at least one vinylaromatic compound.

25. The process according to any of claims 19 to 24, wherein polymerization is effected at a temperature of at least 0° C.

26. A copolymer formed from monomers comprising isobutene and at least one vinylaromatic compound, obtainable by a process according to any of claims 19 to 25.
